(19) United States
(12) Patent Application Publication
(10) Pub. No.: US 2014/0377521 A1
(43) Pub. Date: Dec. 25, 2014

(54) SUPPORT FILM, IN PARTICULAR FOR AN ADHESIVE TAPE AND USE THEREOF

(71) Applicant: tesa SE, Hamburg (DE)

(72) Inventors: Ilse RODEWALD, Hamburg (DE); Bernhard MÜSSIG, Seevetal (DE); Uwe MICHEL, Berlin (DE)

(21) Appl. No.: 14/330,688

(22) Filed: Jul. 14, 2014

Related U.S. Application Data
(63) Continuation of application No. 12/863,885, filed on Oct. 19, 2010, now abandoned.

(30) Foreign Application Priority Data
Jan. 22, 2008 (DE) 102008005563.8

(51) Int. Cl. C09J 7/02

(52) U.S. Cl. CPC C09J 7/0235; C09J 2423/006
USPC 428/213; 428/516; 428/220; 428/352

(57) ABSTRACT

Support film, in particular for an adhesive tape that is stretched monoaxially in the longitudinal direction and that contains a base layer made of polypropylene and a co-extrusion layer made of polyethylene, characterized in that the tension in the longitudinal direction at 10% strain is at least 150 N/mm², preferably at least 200 N/mm², most preferably at least 250 N/mm² and a separating enamel coat is applied to the exterior side of the co-extrusion layer.

This application is a continuation of U.S. application Ser. No. 12/863,885 filed Oct. 19, 2010, which is a 371 application of PCT/EP2009/050610 filed Jan. 12, 2009, which claims priority to the German application DE 10 2008 005 563.8 filed Jan. 22, 2008.

The invention relates to a carrier film, in particular for an adhesive tape, and to use thereof.

Films with a high longitudinal strength are typically achieved by orienting extruded film webs of partially crystalline thermoplastics. The orientation in question is predominantly biaxial. In exceptional cases, the longitudinal tensile strength of the films is further increased by orientation only in longitudinal direction. Both commercially customary biaxially and monoaxially oriented films based on polypropylene, however, have low tear propagation resistances in transverse direction, in contrast to unoriented films from the blown-film or cast-film process.

In practice, in the case of damaged edges of film or adhesive tape (caused by blunt blades on slitting or later unintended damage to the cut edge), this results in the film, or the adhesive tape produced from it, readily suffering tears or tear removal under tensile load.

Where exacting requirements are imposed with regard to tensile strength and tear propagation resistance, films and adhesive tapes are reinforced with filaments or meshes comprising filaments made of glass or plastic. The production of such filament adhesive tapes is very involved from the equipment standpoint and is therefore expensive and susceptible to faults. Besides the base film, there is an additional requirement for the filaments and laminating adhesives (or an additional coating of pressure-sensitive adhesive), and this makes the products more expensive still. Further disadvantages of such filament adhesive tapes are low crease fracture resistance, high thickness, unclean slit edges, and the absence of weldability and recyclability. The production of an adhesive tape of this kind is described in U.S. Pat. No. 4,454,192 A1, for example.

DE 21 04 817 A1 describes a process for producing an adhesive tape carrier of polyolefin (polyethylene or polypropylene). By orientation in the longitudinal direction the intention is to allow a tensile strength in longitudinal direction of 320 N/mm² to be achieved (according to claim 2; no example present). Draw ratio and attained stress at 10% elongation are not disclosed.

Subject matter of EP 0 255 866 A1 is a polypropylene film oriented biaxially or in longitudinal direction. The addition of elastomeric components increases the tensile impact strength in transverse direction. This measure, however, results in a deterioration in the tensile strength and in the tear propagation resistance in transverse direction. The draw ratio in longitudinal direction is 1:5.5 to 1:7. Tensile strengths of 12 to 355 N/mm² are achieved. Details of the stresses at 10% elongation are not given.

At the end of the 1980s, the company Beiersdorf (Hamburg, Germany) marketed a tear-open strip exhibiting a reduced propensity toward tear removal. This strip contained a longitudinally oriented carrier film from the company NOPI (Harrislee, Germany) which was produced by coextruding raw materials of different toughnesses and had a draw ratio of 1:7.5. The strong outer coextrusion layer, in accordance with the principle of impact modifiers, reduces the formation of microtears when the product is slit with sharp blades. It does not, however, prevent tears caused by subsequently damaged edges (for example, during transport of the roll or during application to the carton); this requires a considerably higher tear propagation resistance. The outer layer contains 60% by weight of polypropylene copolymer with about 5% by weight of ethylene and, to increase the toughness, 40% by weight of SBS rubber, which impairs the light stability and leads in particular to reduced tensile strength (160 N/mm²) and reduced stress at 10% elongation (70 N/mm²) of the film in longitudinal direction. The less tough main layer contains 92% by weight of the polypropylene copolymer and 8% by weight of the SBS rubber.

DE 44 02 444 A1 relates to an adhesive tape which possesses tensile strength and is based on monoaxially oriented polyethylene. It is possible in some respects to achieve mechanical properties similar to those of corresponding polypropylene products. Polyethylene, however, has a significantly lower heat resistance than polypropylene, which is manifested disadvantageously not only during the production of the adhesive tape (drying of adhesive layers or other layers in the oven) but also in the course of subsequent packaging applications as a grip tape, adhesive carton-sealing tape, tear-open strip or carton reinforcement strip. The adhesive tapes on the cartons often become hot, for example as they pass through printing machines or after the cartons have been filled with hot goods (foodstuffs, for example). Another disadvantage of polyethylene films (including oriented polyethylene films) in comparison to polypropylene films is the significantly lower force at 10% elongation. As a result of the greater elongation for a given force, grip tapes or adhesive carton-sealing tapes produced from such films tend to detach under tensile load, and carton reinforcement strips cannot prevent cartons suffering tears. The draw ratio in longitudinal direction and attainable stresses at 10% elongation are not disclosed. Tensile strengths are achieved of 102 to 377 N/mm².

EP 0 871 567 A1 relates to a film based on monoaxially oriented polyethylene for label applications. Through the use of PP-RC, a high transparency is achieved, but heat resistance, tensile strength, and stress at 10% elongation are each low, something which is of only minor importance for label applications, in contrast to adhesive tapes.

The inventions described above have found applications, but have fallen far short of achieving the tensile strengths and tear propagation resistances of filament adhesive tapes. Consequently there have been attempts to avoid the involved application of numerous filament threads and to impart filament-like properties to the oriented films by means of longitudinal structures, as described below.

U.S. Pat. No. 5,145,544 A1 and U.S. Pat. No. 5,173,141 A1 describe an adhesive tape comprising monoaxially oriented film which has a rib structure for reinforcement, the ribs partly protruding from the surface and partly being embedded into the film surface. Between film and ribs, notched joints are formed. The invention attains a high lateral tear resistance, but the tensile strength and stretchability are still in need of improvement. The main defect, however, is that a film in accordance with that invention cannot be produced on the production scale. The reasons for this are the poor orientability in customary width and also an extremely poor flat lie, meaning that the capacity for coating with pressure-sensitive adhesive is no longer ensured. At high widths, moreover, there is a further deterioration in the flat lie as a result of nonuniform and inadequate adhesion (caused by the film not lying on flatly) on the drawing rolls in the subsequent orienting operation. In the case of manufacturing in standard production width, the film is held in the middle region on the drawing rolls in transverse direction, causing the rib structure to alter through orienting and causing the entire product quality to become inhomogeneous. A further disadvantage is the need to embed at least 50% of the ribs using a calender, which is a very expensive capital investment and which makes the operation much more involved. The rib structure on the surface also results readily in coating defects when release agents or primers are applied in the course of further processing to adhesive tapes, since the application methods for films require a smooth surface. Imprints of reinforcing filaments or rib structures in the surface of films are a disadvantage for printing, which requires smooth surfaces. Particularly when the film of the invention is utilized for an adhesive packaging tape, printability is an important criterion as far as customers are concerned. U.S. Pat. No. 5,145,544 A1 reveals a draw ratio of 1:7 and tensile strengths of 157 to 177 N/mm²; stresses at 10% elongation are not ascertained. U.S. Pat. No. 5,173,141 A1 reveals draw ratios of 1:6.1 to 1:7 and tensile strengths of up to 245 N/mm²; stresses at 10% elongation are not ascertained.

EP 1 101 808 A1 attempts to eliminate the aforementioned disadvantages by moving the rib structures into the interior of the film. The film has plane-parallel outer sides and comprises at least two coextruded layers whose compositions are different and whose interface is not planar but instead in cross section exhibits a nonlinear boundary profile, which continues in a laminar fashion in the longitudinal direction. The particular internal structure of the film is the result of periodic or irregular variations in the thickness of one layer in transverse direction, and of the compensation by the second layer of the fluctuations in thickness, in such a way that the overall thickness is substantially constant. All of the cited inventions exhibit improved tensile strength and elasticity modulus in longitudinal direction as compared with a standard adhesive tape film. The draw ratios are between 1:6.7 and 1:8.7. As far as tensile strengths are concerned, 202 to 231 N/mm² are achieved, and, as far as stresses at 10% elongation are concerned, 103 to 147 N/mm² are achieved.

EP 0 353 907 A1 employs the concept of the fibrillation of films. In that invention an adhesive tape is produced from a carrier layer which is bonded to a further layer of a fibrillated polymer film. The fibrillated side is subsequently coated with adhesive. The polymer film for fibrillation is preferably extruded, is composed of polypropylene, and is subsequently drawn monoaxially in machine direction. This likewise very involved process has the disadvantage that the laminate must be produced in four operational steps (extruding, drawing, fibrillating, and adhesive bonding of the fibrils on the PP-BO carrier film). The thickness of the films of EP 0 353 907 A1 is approximately 25 μm (PP-BO) and approximately 5 μm (oriented PP film). Accordingly it is possible to achieve tensile strengths of only 99 to 176 N/cm and tear propagation resistances of only 15 to 22 N/cm.

None of these inventions is implemented industrially, since the production processes are very involved. Furthermore they fall far short of being able to match the properties of products featuring glass filaments or polyester filaments.

The draw ratio of commercially customary, monoaxially oriented polypropylene films which are used as a carrier in an adhesive tape is approximately 1:7.

If the draw ratio is increased in order to increase the tensile strength and the stress at 10% elongation, it is found that, above a draw ratio of 1:8, the film becomes damaged by a release coating based on polyvinyl stearylcarbamate in toluene. The release-coated film surface is sensitive to friction. If friction is generated on the coated surface with an eraser, the surface breaks down into fine fibers. Fiberization of the surface through friction in coating or slitting units may lead to delamination of the film (“shredding”) even as the adhesive tape is being unwound.

In operational practice, furthermore, cartons with adhesive tapes for reinforcement or tear-opening are stacked. When individual unerected cartons are withdrawn from the stack, friction occurs against the adhesive tape. Friction also occurs when the cartons are being processed on packaging lines. Operational frictions of these kinds lead to the extraction of polypropylene fibers from the surface.

The degree of such damage increases as the draw ratio goes up (for example, 1:10).

Commercially customary, monoaxially oriented polypropylene films for adhesive tapes are produced from polypropylene having a flexural modulus of approximately 1200 MPa or from a mixture of a relatively hard polypropylene and PE-LLD having a similar (weighted calculated) flexural modulus. If an attempt is made to raise the force at 10% elongation by using polypropylene with a higher flexural modulus than usual, it is found that this measure as well is accompanied by damage to the film through release coatings. This becomes very marked in the case of films made from polypropylene raw materials that have a flexural modulus of 1600 MPa or more, and becomes particularly extreme from a flexural modulus of 2000 MPa.

If a silicone-based release coating is used, the consequences are even more serious. The film is damaged even more greatly by silicone than by polyvinyl stearylcarbamate. On the one hand, the damage occurs even at lower draw ratios than 1:8, and, on the other hand, the damage to the film is observed not only on the side of the coating but even on the opposite side, as if the silicone migrated through the film.

It is an object of the invention to provide a carrier film, in particular for an adhesive tape, which has a very high tensile modulus, or a very high stress at 10% elongation in longitudinal direction, which is not damaged by a release coating, particularly not even by a silicone-based released coating, and which does not have the aforementioned disadvantages of the prior-art films.

This object is achieved by means of a film as characterized in more detail in the main claim. The dependent claims describe advantageous embodiments of the invention. Furthermore, the use of the film of the invention is encompassed by the concept of the invention.

The invention accordingly provides a carrier film, in particular for an adhesive tape, which is oriented monoaxially in the longitudinal direction and which comprises a base layer of polypropylene and a coextrusion layer of polyethylene, where the stress in longitudinal direction at 10% elongation is at least 150 N/mm², preferably at least 200 N/mm², very preferably at least 250 N/mm², a release coating is applied on the outer side of the coextrusion layer. Typical monoaxially oriented films are provided with a release coating in order to allow an adhesive tape produced using such films to be unwound easily and without damage to the film. With high-modulus films of this kind, however, release coatings lead to damage to the surface by fiber extraction. Toluene, as a common solvent for release coatings (release agents), on its own has a damaging effect, which is further reinforced by release agents such as polyvinyl stearylcarbamate. The behavior of silicones is especially damaging, and in that case even the underside of the film (the side facing away from the release coating) becomes sensitive to fiber extraction. Fiber extraction when the adhesive tape is being unwound leads to delamination of the film (“shredding”). In the present invention, these negative effects can be prevented by an additional coextrusion layer of polyethylene.

The carrier film can be produced in analogy to the relatively simple extrusion process for monoaxially oriented polypropylene films. It has an increased stress at 10% elongation, and has tensile strengths in longitudinal direction that lie between those of conventional monoaxially oriented polypropylene films and those of fiber-reinforced carriers for filament adhesive tapes, but does not require the involved process for producing filament adhesive tapes.

The polypropylene film most frequently used for adhesive tapes is PP-BO (biaxially oriented polypropylene film). These have very low stresses at 10% elongation.

In order to obtain high tensile strengths and high stresses at 1% and 10% elongation, the conditions in the orienting operation ought to be selected such that the draw ratio is the maximum technically implementable draw ratio for the respective film. In accordance with the invention, the draw ratio in longitudinal direction is at least 1:8, preferably at least 1:9.5.

A draw ratio of, for example, 1:6 indicates that a primary film section 1 m long produces a drawn film section 6 m long. The draw ratio is often also referred to as the ratio of the linear speed prior to orientation to the linear speed after orientation.

Suitable polypropylene film base materials for the base layer of this invention are commercially available polypropylene polymers. The melt index is to be within the range suitable for flat film extrusion. The melt index ought to be between 0.3 and 15 g/10 min, preferably in the region of 0.8 and 5 g/10 min (measured at 230° C./2.16 kg).

For the subject matter of the invention it is preferred to use a polypropylene having a flexural modulus of at least 1600 MPa, more preferably at least 2000 MPa.

In order to maximize values for stresses at 1% and 10% elongation, and in order to maximize tensile strength values, it is advantageous to employ highly isotactic polypropylene or to use nucleating agents. All nucleating agents suitable for polypropylene (α or β crystals) are appropriate.

These are organic nucleating agents such as, for example, benzoates, phosphates or sorbitol derivatives. Nucleating agents of this kind are described for example in the section “9.1. Nucleating Agents” in Ullmann's Encyclopedia of Industrial Chemistry (2002 edition from Wiley-VCH Verlag, Article Online Posting Date Jun. 15, 2000) or in the examples of US 2003/195300 A1. Another particularly suitable method is the use of a semicrystalline branched or coupled polymeric nucleating agent, as described in US 2003/195300 A1, as for example a polypropylene modified with 4,4′-oxydibenzenesulfonyl azide.

The base layer may comprise further polymers, more particularly polyolefins. Preference is given to a very high fraction of polypropylene or polypropylenes, and particular preference to no addition of further polymers.

The carrier film preferably has no rib structures on the surfaces, since such structures impair the adhesion during the drawing operation and do not allow homogeneous orientation. In the interior as well there are preferably no rib structures provided; instead, the layers are of plane-parallel orientation. In that case there is no need to provide an involved die which is susceptible to faults.

Furthermore, preferably, the carrier film does not comprise carbon nanotubes.

The problem of the extraction of fibers from the release-coated top face can be solved, surprisingly and unexpectedly for the skilled worker, by a coextrusion layer of polyethylene.

Suitable polyethylenes for the coextrusion layer are PE-LD, PE-LLD, PE-VLLD, and PE-HD. In a minor amount, the polyethylene may comprise further monomers such as propene, butene, hexene, octene, ethyl acrylate or vinyl acetate. Preference is given to ethylene homopolymers such as PE-LD or more particularly PE-HD.

To improve the adhesion between the two layers (base layer and coextrusion layer) it is preferred to add a polypropylene-compatible polymer to the coextrusion layer, such as, for example, a propylene-containing polymer, polybut-1-ene or hydrogenated styrene-diene block copolymer such as SEBS, SEPS or SEBE.

The fraction of polyethylene in the coextrusion layer is preferably between 50% and 100% by weight, more preferably between 60% and 80% by weight.

The release coating is applied to the coextrusion layer provided in accordance with the invention, but the film may also have other, identical or different, layers produced by coextrusion.

It is thought that, at the orienting temperature employed, the base layer of polypropylene forms a fiber structure with high modulus, but the polyethylene coextrusion layer does not. It appears that the spaces between the fibers can draw up the release coating under suction, which then permanently induces a release effect between the fibers, since the solvent alone does not cause such drastic damage. The coextrusion layer is unable, presumably for a lack of significant fiber structure with spaces between the fibers, to draw up the release coating under suction.

The layers may, besides the polymers, comprise additives such as antioxidants, light stabilizers, antiblocking agents, lubricants, processing assistants, fillers, dyes and/or pigments.

The carrier film, by selection of draw ratio, orienting temperature and/or the flexural modulus of polypropylene, has a stress at 10% elongation in longitudinal direction of at least 150 N/mm², of preferably at least 200 N/mm², of more preferably at least 250 N/mm².

In a preferred embodiment the carrier film, or an adhesive tape produced using the carrier film, possesses in longitudinal direction (machine direction) a stress at 1% elongation of at least 20 N/mm², preferably at least 40 N/mm² and/or a tensile strength of at least 300 N/mm², preferably at least 350 N/mm². The tear propagation resistance in transverse direction is intended to attain preferably at least 80 N/mm, more particularly at least 220 N/mm.

For the calculation of strength values, the width-related force values are divided by the thickness. In the case where strength values are determined on the adhesive tape, the thickness taken as a basis is not the total thickness of the adhesive tape, but only that of the carrier film.

The thickness of the carrier film is preferably between 25 and 200 μm, more preferably between 40 and 140 μm, very preferably between 50 and 90 μm.

The thickness of the coextrusion layer is preferably 3% to 20%, more preferably 5% to 10%, of the total film thickness. In accordance with the invention the thickness chosen for the coextrusion layer is as small as possible, since it makes a negative contribution to the stress at 1% and 10% elongation and to the tensile strength, in view of the fact that this layer is composed of a material whose mechanical data are weaker than those for the raw materials of the base layer.

The layer, however, prevents the penetration of release agent from the release coating into the base layer.

The thickness of the coextrusion layer has lower limits, of course, for technical reasons, in order that, within thickness fluctuation, it does not become zero, i.e., in a worst case scenario, is not completely absent in some places.

The film may be modified by lamination, embossing or radiation treatment. The films may have been given surface treatments. These treatments are, for example, to promote adhesion, corona treatment, flame treatment, fluorotreatment or plasma treatment, or coatings of solutions or dispersions or liquid, radiation-curable materials.

The carrier film has a release coating on the coextrusion layer (abhesive coating, nonstick coating), which is composed, for example, of silicone, of acrylates (for example, Primal® 205), of stearyl compounds such as polyvinyl stearylcarbamate or chromium stearate complexes (for example, Quilon® C) or reaction products of maleic anhydride copolymers and stearylamine. Preference is given to a silicone-based release coating. The silicone may be applied solventlessly or containing solvent, and may be crosslinked by radiation, by a condensation or addition reaction, or physically (for example, by a block structure).

With particular advantage, the carrier film of the invention can be used in an adhesive tape, by application of an adhesive to at least one side of the carrier film.

A preferred adhesive tape in accordance with the invention is a film having a self-adhesive or heat-activatable layer of adhesive. The adhesives in question, however, are preferably not sealable adhesives, but rather pressure-sensitive adhesives. For the adhesive tape application, the carrier film is coated on one side with pressure-sensitive adhesive in the form of a solution or dispersion or in 100% form (from the melt, for example), or by coextrusion with the carrier film. The layer of adhesive is located on the side of the film with the base layer. The adhesive layer can be crosslinked by means of heat or high-energy radiation and can if necessary be lined with release film or release paper. Especially suitable pressure-sensitive adhesives are PSAs based on acrylate, natural rubber, thermoplastic styrene block copolymer or silicone.

The general expression “adhesive tape” in the context of this invention encompasses all sheetlike structures, such as two-dimensionally extended films or film sections, tapes with extended length and limited width, tape sections and the like, and also, lastly, die cuts or labels.

In order to optimize the properties it is possible for the self-adhesive employed to have been blended with one or more additives such as tackifiers (resins), plasticizers, fillers, pigments, UV absorbers, light stabilizers, aging inhibitors, crosslinking agents, crosslinking promoters or elastomers.

Suitable elastomers for blending are, for example, EPDM rubber or EPM rubber, polyisobutylene, butyl rubber, ethylene-vinyl acetate, hydrogenated block copolymers of dienes (for example, through hydrogenation of SBR, cSBR, BAN, NBR, SBS, SIS or IR; such polymers are known, for example, as SEPS and SEBS) or acrylate copolymers such as ACM.

Tackifiers are, for example, hydrocarbon resins (for example, those of unsaturated C₅ or C₇ monomers), terpene-phenolic resins, terpene resins formed from raw materials such as α- or β-pinene, aromatic resins such as coumarone-indene resins or resins of styrene or α-methylstyrene, such as rosin and its derivatives, such as disproportionated, dimerized or esterified resins, in which context it is possible to use glycols, glycerol or pentaerythritol. Particularly suitable are aging-stable resins without an olefinic double bond, such as hydrogenated resins, for example.

Examples of suitable fillers and pigments are carbon black, titanium dioxide, calcium carbonate, zinc carbonate, zinc oxide, silicates or silica.

Suitable UV absorbers, light stabilizers, and aging inhibitors for the adhesives are those as listed in this specification for the stabilization of the film.

Examples of suitable plasticizers include aliphatic, cycloaliphatic, and aromatic mineral oils, diesters or polyesters of phthalic acid, trimellitic acid or adipic acid, liquid rubbers (for example, nitrile rubbers or polyisoprene rubbers), liquid polymers of butene and/or isobutene, acrylic esters, polyvinyl ethers, liquid resins and plasticizer resins based on the raw materials for tackifier resins, wool wax and other waxes, or liquid silicones.

Examples of crosslinking agents are phenolic resins or halogenated phenolic resins, melamine resins and formaldehyde resins. Examples of suitable crosslinking promoters are maleimides, allyl esters such as triallyl cyanurate, and polyfunctional esters of acrylic and methacrylic acid.

In preferred embodiments the pressure-sensitive adhesive comprises pale and transparent raw materials. Particularly preferred are acrylate PSAs (for example in dispersion form) or PSAs comprising styrene block copolymer and resin (for example, of the kind typical for hotmelt PSAs).

The coating thickness with adhesive is preferably in the range from 18 to 50 g/m², more particularly 22 to 29 g/m². The width of the adhesive-tape rolls is preferably in the range from 2 to 60 mm.

The film can be used, for example, as a carrier for an adhesive tape. An adhesive tape of this kind is suitable for reinforcing cardboard packaging, particularly in the region of die cuts, as a tear-open strip for cartons, as a carry handle, for pallet securement, and for bundling articles. Examples of such articles include pipes, profiles or stacked cartons (strapping application).

In comparison to EP 0 353 907 A1, the carrier film is produced in only two steps (extrusion, orienting) in-line on one line, and also has very much higher tear propagation resistances in transverse direction (approximately 300 N/cm at 70 μm thickness).

### Test Methods

### Thickness: DIN 53370

Tensile strength: DIN 53455-7-5 in longitudinal direction
Stress at 1% or 10% elongation: DIN 53455-7-5 in longitudinal direction
Elongation at break: DIN 53455-7-5 in longitudinal direction
Melt index: DIN 53735
The Melt Flow Ratio (MFR) melt index is measured in accordance with DIN 53735. For polyethylenes, melt indices are usually specified in g/10 min at 190° C. and a weight of 2.16 kg, and for polypropylenes similarly but at a temperature of 230° C.
   Flexural modulus: ASTM D 790 A

### Density: ASTM D 792

Crystallite melting point: determined by DSC in accordance with ISO 3146
Nomenclature of the plastics: ISO 1043-1
Friction test:
10 strokes with an Edding A 20 eraser having a rounded corner (radius of curvature=5 mm) in machine direction, with an applied pressure of 5 kiloponds on the release-coated side.
   Evaluation: pass=no abrasion;
      fail=fibers are rubbed out of the surface
         Technical adhesive data: AFERA 4001, corresponding to DIN EN 1939

The invention is illustrated below by reference to examples, which do not restrict it.

### EXAMPLES

### Raw Materials

### Dow 7C06: PP-BC:

MFI 1.5 g/10 min, non-nucleated, flexural modulus 1280 MPa, crystallite melting point 164° C. (Dow Chemical)

### Moplen HP 501 D:

Identified on the data sheet as a homopolymer, but according to information from the manufacturer is a copolymer with 1.5% by weight ethylene, MFI 0.7 g/10 min, non-nucleated, flexural modulus 1450 MPa, crystallite melting point 161° C. (Basell)

### Dow Inspire 404.01:

Polypropylene, MFI 3 g/10 min, nucleated, flexural modulus 2068 MPa, nucleated (with a polymeric nucleating agent in accordance with US 2003/195300 A1), crystallite melting point 164° C. (Dow Chemical)

### HTA 108:

PE-HD, MFI 0.7 g/10 min, non-nucleated, flexural modulus about 1800 MPa, density 0.961 g/cm³, crystallite melting point 133.5° C. (Exxonmobil)

### Dowlex 2032:

PE-LLD, MFI 2.0 g/10 min, density 0.9260 g/cm³, crystallite melting point 124° C. (Dow Chemical)

### ADK STAB NA-11 UH:

Nucleating agent (Adeka Palamarole)

### Remafingelb HG AE 30:

PP pigment masterbatch with translucent pigment (Clariant Masterbatches)

### Release Coat RA95D:

PVSC=polyvinyl stearylcarbamate (k+k-Chemie)

### Dehesive 940A:

Silicone solution (Wacker Chemical)

### Crosslinker V24:

Crosslinking agent (Wacker Chemical)

### Catalyst OL:

Catalyst agent (Wacker Chemical)

### Example 1

A two-layer film is coextruded on a single-screw extrusion unit with a flat die with flexible die lip, followed by a chill roll station and a single-stage short-gap orienting unit. The base layer is composed of Inspire D 404.01, and the coextrusion layer is composed of 68% by weight of Dowlex 2032 and 32% by weight of Dow 7C06. The die temperature is 235° C. Chill roll temperatures and drawing roll temperatures are set so as to maximize the crystallinity of the film before and after the drawing operation. The draw ratio is 1:10.

### Test Results:

Film properties:

| | | |
|---|---|---|
| Carrier thickness after orientation | 75 | μm |
| Thickness of the base layer | 70 | μm |
| Thickness of the coextrusion layer | 5 | μm |
| Stress at 1% elongation | 66 | N/mm² |
| Stress at 10% elongation | 270 | N/mm² |
| Tensile strength | 297 | N/mm² |

| | |
|---|---|
| Elongation at break | 8% |
| Friction test | pass |

The film is corona-pretreated on both sides, coated on the coextrusion layer with a 0.5% release solution of Release Coat RA95D in toluene, and dried. The adhesive is mixed in the melt from 42% by weight of SIS elastomer, 20% by weight of pentaerythritol ester of hydrogenated rosin, 37% by weight of a C₅ hydrocarbon resin having an R&B value of 85° C., and 1% by weight of Irganox® 1010 antioxidant, and is applied at 150° C. with a nozzle to the bottom face of the film. The adhesive tape is subsequently wound to form a stock roll, and for further testing is slit to a width of 15 mm.

Technical adhesive data:
bond strength to steel 2.2 N/cm
unwind force at 0.3 m/min 1.0 N/cm
coat weight 23 g/m².

### Example 2

The film is produced in the same way as in example 1, but with the draw ratio set at 1:8. Raw material used for the base layer is a mixture of 98.9 parts by weight Moplen HP 501 D, 0.9 part by weight Remafingelb HG AE 30 and 0.2 part by weight of ADK STAB NA-11 UH. The coextrusion layer is composed of 75% by weight of HTA 108 and 25% by weight of Moplen HP 501 D.

Test results:
Film properties:

| | | |
|---|---|---|
| Carrier thickness after orientation | 64 | μm |
| Thickness of the base layer | 60 | μm |
| Thickness of the coextrusion layer | 4 | μm |
| Stress at 1% elongation | 33 | N/mm² |
| Stress at 10% elongation | 246 | N/mm² |
| Tensile strength | 290 | N/mm² |

| | |
|---|---|
| Elongation at break | 33% |
| Friction test | pass |

The film is corona-pretreated on both sides and then provided on the coextrusion layer (top face) with a silicone release coating. The latter is composed of 21 800 parts by weight of heptane, 3126 parts by weight of Dehesive 940A, 8 parts by weight of methylbutynol, 23 parts by weight of Crosslinker V24, and 31 parts by weight of Catalyst OL. The bottom face is provided with a primer comprising natural rubber, cyclorubber, and 4,4′-diisocyanatodiphenylmethane.

The adhesive is dissolved in hexane, in a kneading apparatus, from 40% by weight of natural rubber SMRL (Mooney 70), 10% by weight of titanium dioxide, 37% by weight of a C₅ hydrocarbon resin having an R&B value of 95° C., and 1% by weight of Vulkanox® BKF antioxidant. The 20% strength by weight of adhesive is applied using a coating bar to the primed bottom face of the film, and is dried at 115° C. The adhesive tape is then wound to form a stock roll and for further testing is slit to a width of 15 mm.

Technical adhesive data:
bond strength to steel 1.9 N/cm
unwind force at 0.3 m/min 0.2 N/cm
coat weight 24 g/m².

### Comparative Example 1

Production is as in example 1, but without a coextrusion layer.

Test results:
Film properties:

| | | |
|---|---|---|
| Carrier thickness after orientation | 70 | μm |
| Stress at 1% elongation | 71 | N/mm² |
| Stress at 10% elongation | 280 | N/mm² |
| Tensile strength | 317 | N/mm² |

| | |
|---|---|
| Elongation at break | 7% |
| Rubbing test | fail |

### Comparative Example 2

Production is as in example 2, but the cover layer has the same composition as the base layer.

Test results:
Film properties:

| | | |
|---|---|---|
| Carrier thickness after orientation | 65 | μm |
| Thickness of the base layer | 60 | μm |
| Thickness of the cover layer | 5 | μm |
| Stress at 1% elongation | 37 | N/mm² |
| Stress at 10% elongation | 258 | N/mm² |
| Tensile strength | 310 | N/mm² |

| | |
|---|---|
| Elongation at break | 32% |
| Rubbing test | fail |

### Comparative Example 3

A film and an adhesive tape are produced in the same way as in comparative example 1, from Dow 7C06, with a draw ratio of 1:6.1.

Test results:

| | | |
|---|---|---|
| Carrier thickness after orientation | 80 | μm |
| Tensile strength | 247 | N/mm² |
| Stress at 1% elongation | 19 | N/mm² |
| Stress at 10% elongation | 142 | N/mm² |

| | |
|---|---|
| Elongation at break | 27% |
| Rubbing test | pass |

### Comparative Example 4

Production is as in example 1, but the coextrusion layer is composed of Dow 7C06.

Test results:
Film properties:

| | | |
|---|---|---|
| Carrier thickness after orientation | 75 | μm |
| Thickness of the base layer | 70 | μm |
| Thickness of the coextrusion layer | 5 | μm |
| Stress at 1% elongation | 72 | N/mm² |
| Tensile strength | 280 | N/mm² |

| | |
|---|---|
| Elongation at break | 6% |
| Rubbing test | fail |

1. A carrier film for an adhesive tape, which is oriented monoaxially in longitudinal direction and which comprises a base layer of polypropylene and a coextrusion layer of polyethylene, wherein the stress in longitudinal direction at 10% elongation is at least 150 N/mm² and further comprises a release coating applied on the outer side of the coextrusion layer, and further wherein the film has a draw ratio in the longitudinal direction of at least 1:8.

2. The carrier film according to claim 1, wherein the carrier film,
has a tensile strength in longitudinal direction of at least 300 N/mm², and
has a stress in longitudinal direction at 1% elongation of at least 20 N/mm².

3. The carrier film according to claim 1, wherein the carrier film has a thickness of 25 to 200 μm.

4. The carrier film according to claim 1, wherein the base layer comprises a polypropylene with a melt index of 0.3 to 15 g/10 min, and with a flexural modulus of at least 1600 MPa.

5. The carrier film according to claim 1, wherein the polypropylene of the base layer is nucleated.

6. The carrier film according to claim, 1 wherein the fraction of polyethylene in the coextrusion layer is between 50% and 100% by weight.

7. The carrier film as according to claim 1, wherein the polyethylene of the coextrusion layer is a homopolymer.

8. The carrier film according to claim 1, wherein the thickness of the coextrusion layer is 3% to 20% of the total film thickness.

9. The carrier film according to claim 1, wherein the film comprises an adhesive applied to at least one side of the film.

10. (canceled)

11. The carrier film according to claim 1 wherein the stress in longitudinal direction at 10% elongation is at least 200 N/mm².

12. The carrier film according to claim 7 wherein the homopolymer is high-density polyethylene.
